(19) United States
(12) Patent Application Publication
(10) Pub. No.: US 2007/0188440 A1
(43) Pub. Date: Aug. 16, 2007

(54) Apparatus and method for displaying graphic object with low power consumption

(75) Inventors: Joo-young Hwang, Suwon-si (KR); Min-sung Jang, Seoul (KR); Jae-Kyoung Bae, Suwon-si (KR); Ha-young Kim, Suwon-si (KR); Alexander Kirnasov, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/653,915

(22) Filed: Jan. 17, 2007

(30) Foreign Application Priority Data
Feb. 10, 2006 (KR) 10-2006-0013264

(51) Int. Cl. G09G 3/36

(52) U.S. Cl. 345/102

(57) ABSTRACT

Provided are an apparatus and method for displaying a graphic object with low power consumption, more particularly, an apparatus and method for displaying a graphic object with low power consumption that reduces power consumption by adjusting complexity and surfaces properties of the graphic object that is displayed and increasing transmittance of light emitted a light source of a liquid crystal display device. The apparatus includes a remaining power checking unit checking the remaining amount of power that is supplied, a graphics management unit converting properties of the graphic object on the basis of the remaining power, a light source management unit adjusting intensity of light emitted from a light source on the basis of the remaining power, and a display unit displaying the graphic object whose properties are converted with the adjusted intensity of the light emitted from the light source.

### CROSS REFERENCE TO RELATED APPLICATION

This application claims priority from Korean Patent Application No. 10-2006-0013264 filed on Feb. 10, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying a graphic object with low power consumption, and more particularly, to displaying a graphic object with low power consumption that reduces power consumption by adjusting complexity and surfaces properties of the graphic object that is displayed and increasing transmittance of light emitted from a light source of a liquid crystal display device.

2. Description of the Related Art

With the spread of Windows and the advent of the Internet, developments in graphical user interface (hereinafter, simply referred to as “GUI”) have been making rapid progress. The GUI that provides user-friendly and intuitive information in various environments has been developed and used.

The GUI is used to achieve the convenient use of computers, and the rapid and intuitive information transmission. The user moves a mouse pointer using a mouse and clicks or double-clicks an icon indicated by the mouse pointer so as to instruct a user's desired operation to the computer. Further, the GUI is used to display information, such as files or other kinds of data. In this case, the information can be displayed through a separate dialog window, a balloon help, or the like.

Meanwhile, with the development of the integration techniques, various portable terminals have appeared. Start with acoustic players, such as recent tape players and CD players, pagers have appeared. At the present, cellular phones and MP3 players have become widespread, and portable game machines have appeared.

Further, the start of a digital multimedia broadcasting (DMB) service is expected to stimulate the demand for portable terminals providing the DMB service. When an AirTV service starts later, the spread of the portable terminals is expected to be further expanded.

As such, with the spread of the portable terminals, GUIs to be displayed attract a user's attention. Accordingly, various GUIs are developed and provided.

A graphics processing unit is a processor formed of a single chip and is originally used for three-dimensional applications. The graphics processing unit creates 3D scenes that are drawn every time, such as light source effect and object transformation. Creation and display of the 3D scenes are jobs of intensive arithmetic operations and may increase the burden on a central processing unit without the graphics processing unit. The graphics processing unit frees the central processing unit from the burden, and allows cycles of the central processing unit to be used for other jobs.

The graphics processing unit uses technology called a shader such that three-dimensional objects are implemented on a two-dimensional computer screen.

The shader is three-dimensional graphic technology that has been developed as compared with a method of implementing a three-dimensional object by increasing the number of polygons according to the related art. The shader is divided into a vertex shader and a pixel shader.

The vertex shader implements three-dimensional graphic objects using a variety of information, such as, coordinates, colors, and reflection values. Further, the vertex shader is technology that processes complex operating processes with respect to a great amount of data, such as matrices, light sources values, textures, and the coordinates varying according to a change in vertex positions.

Meanwhile, the pixel shader is technology that implements three-dimensional graphic objects using pixels. The textures, which can be implemented by the vertex shader, are expressed in the units of pixels such that more realistic three-dimensional graphic objects are implemented.

FIG. 1 is a block diagram showing an apparatus for displaying a three-dimensional object according to the related art. An apparatus 10 for displaying a three-dimensional object according to the related art (hereinafter, simply referred to as a “display apparatus”) includes a model optimizing unit 11, a graphic operation unit 12, a graphics processing unit 13, and a display unit 14.

The model optimizing unit 11 creates an optimized polygon model with respect to a three-dimensional polygon model inputted. The created polygon model is transmitted to the graphic operation unit 12. The graphic operation unit 12 performs an operation on coordinates and colors of triangle vertices according to the transmitted polygon model. The graphics processing unit 13 generates information on pixels inside the triangles for the coordinates and colors of the vertices of the triangles. The created three-dimensional graphic object is displayed through the display unit 14.

As such, since a large amount of operation is needed to create the three-dimensional graphic object, power consumption is correspondingly increased. Therefore, when the display apparatus 10 is a mobile terminal using a battery as a main power source, the user cannot use the display apparatus 10 as long as the user desires. In other words, when there is the remaining power of about 20 minutes in the display apparatus 10, the user who desires to use the display apparatus 10 for about 30 minutes cannot perform user's jobs for about 10 minutes.

Korean Patent Unexamined Publication No. 2005-015861 discloses a method of saving the power by switching a texture mapping mode that needs high power consumption to a wire frame mode that needs low power consumption when a three-dimensional application is operated in a mobile communication terminal having a three-dimensional engine.

However, since this proposes only a method of reducing the power consumption, it is possible to reduce the power consumption, but a method of maintaining the operation of the apparatus as long as the user desires is not proposed. Therefore, there is a need for the development of a method of changing properties of a graphic object to maintain the operation of the apparatus as long as the user desires.

### SUMMARY OF THE INVENTION

An object of the present invention is to adjust complexity and surface properties of a graphic object that is displayed in consideration of the remaining power of a power supply unit, and to increase transmittance of light from a light source of a liquid crystal display.

Objects of the present invention are not limited to those mentioned above, and other objects of the present invention will be apparently understood by those skilled in the art through the following description.

According to an aspect of the present invention, there is provided an apparatus for displaying a graphic object with low power consumption, the apparatus including a remaining power checking unit checking the remaining amount of power that is supplied, a graphics management unit converting properties of the graphic object on the basis of the remaining power, a light source management unit adjusting intensity of light emitted from a light source on the basis of the remaining power, and a display unit displaying the graphic object whose properties are converted, with the adjusted intensity of the light emitted from the light source.

According to another aspect of the present invention, there is provided a method of displaying a graphic object with low power consumption, the method including checking the remaining amount of power that is supplied, converting properties of the graphic object on the basis of the remaining power, adjusting intensity of light emitted from a light source on the basis of the remaining power, and displaying the graphic object whose properties are converted, with the adjusted intensity of the light emitted from the light source.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram showing an apparatus for displaying a three-dimensional object according to the related art;

FIG. 2 is a block diagram showing an apparatus for displaying a graphic object with low power consumption according to an exemplary embodiment of the present invention;

FIG. 3 is a block diagram showing a graphics management unit according to an exemplary embodiment of the present invention;

FIG. 4 is a diagram showing a control code according to an exemplary embodiment of the present invention;

FIG. 5 is a diagram illustrating edge collapse according to an exemplary embodiment of the present invention;

FIG. 6 is a diagram illustrating determination of pixel properties of a graphic object with reference to a pixel information map according to an exemplary embodiment of the present invention;

FIG. 7 is an exploded perspective view of a liquid crystal display according to an exemplary embodiment of the present invention; and

FIG. 8 is a diagram showing a process of displaying a graphic object with low power consumption according to an exemplary embodiment of the present invention.

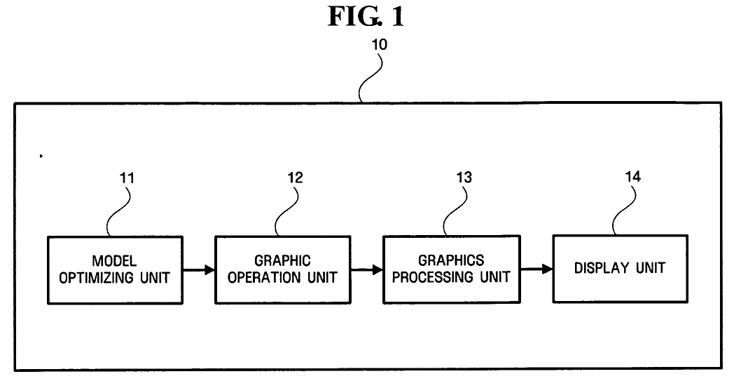

### DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

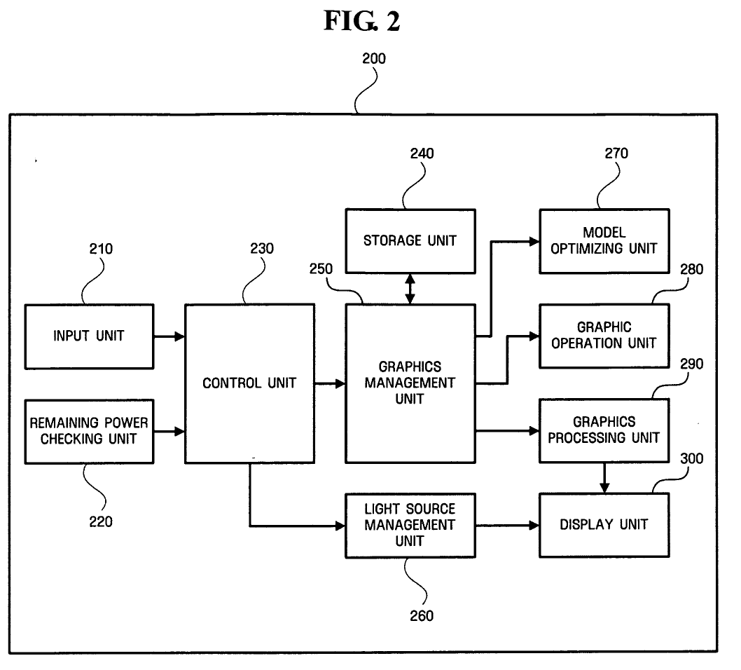

FIG. 2 is a block diagram showing an apparatus for displaying a graphic object with low power consumption according to an exemplary embodiment of the present invention. An apparatus 200 for displaying a graphic object with low power consumption (hereinafter, simply referred to as a “display apparatus”) according to an exemplary embodiment of the present invention includes an input unit 210, a remaining power checking unit 220, a control unit 230, a storage unit 240, a graphics management unit 250, a light source management unit 260, a model optimizing unit 270, a graphic operation unit 280, a graphics processing unit 290, and a display unit 300.

The remaining power checking unit 220 checks the remaining amount of power that is supplied. Before checking the remaining power, the remaining power checking unit 220 checks whether the supplied power is commercial power or power from a battery. When the power supplied is commercial power, the remaining power checking unit 220 may not check the remaining power.

On the other hand, when the power is supplied from a battery, the remaining power checking unit 220 checks the remaining amount of power that may be supplied from the battery, which can be checked by using the voltage of the battery.

The remaining power checking unit 220 keeps on checking the remaining power even when the graphic object is displayed and transmits the checked remaining power to the control unit 230.

The input unit 210 receives the time required for the duration of the display apparatus 200 from a user. The time required for the duration is time that is necessary for the user to display the graphic object desired by the user. Here, the user can input the time required for the duration in the units of hours or minutes. In order to receive the time required for the duration from the user, the input unit 210 may include buttons, wheels, a keypad, or a touch pad.

The control unit 230 operates at least one of the graphics management unit 250 and the light source management unit 260 such that the graphic object can be displayed during the duration requested by the user by using the remaining power. For example, when the commercial power is supplied, the control unit 230 controls the graphics management unit 250 to display the graphic object with the highest image quality and the light source management unit 260 to emit intense light from a light source. On the other hand, when the power is supplied from a battery, the control unit 230 controls the graphics management unit 250 to transform a polygon model, reduce an operation amount, and converts pixel information, and controls the light source management unit 260 to emit weak light from the light source.

The control unit 230 may operate one of the graphics management unit 250 and the light source management unit 260 or may operate both of them. Here, the remaining power changes as the graphic object is displayed. The control unit 230 may select a unit to be operated, referring to the remaining amount of power supplied in real-time. That is, the control unit 230 operates only the graphics management unit 250 when the remaining power is high or only the light source management unit 260 when the remaining power is low. When the remaining power is very insufficient, the control unit 230 may operate both the graphics management unit 250 and the light source management unit 260.

The control unit 230 controls the graphics management unit 250 and the light source management unit 260 by transmitting a control code to the graphics management unit 250 and the light source management unit 260. The control code includes an operation code 410 indicating a corresponding operation and a power code 420 indicating a power decrease rate. A detailed description of the control code will be made below with reference to FIG. 4.

Further, the control unit 230 controls the input unit 210, the remaining power checking unit 220, the storage unit 240, the graphics management unit 250, the light source management unit 260, the model optimizing unit 270, the graphic operation unit 280, the graphics processing unit 290, the display unit 300, and the display apparatus 200.

The storage unit 240 stores a pixel information map. The pixel information map is information for expressing materials of triangles constituting the graphic object. In spite of the same material, pixel information of low and high resolution may be included. Therefore, when the supplied power is sufficient, pixel information of high resolution is extracted, and when the supplied power is insufficient, pixel information of low resolution is extracted.

The storage unit 240 is a module that allows input and output of information, such as a hard disc, a flash memory, a compact flash (CF) card, a secure digital (SD) card, a smart media (SM) card, a multimedia (MMC) card, or a memory stick. Further, the storage unit 240 may be provided in the display apparatus 200, or it may be provided in a separate apparatus.

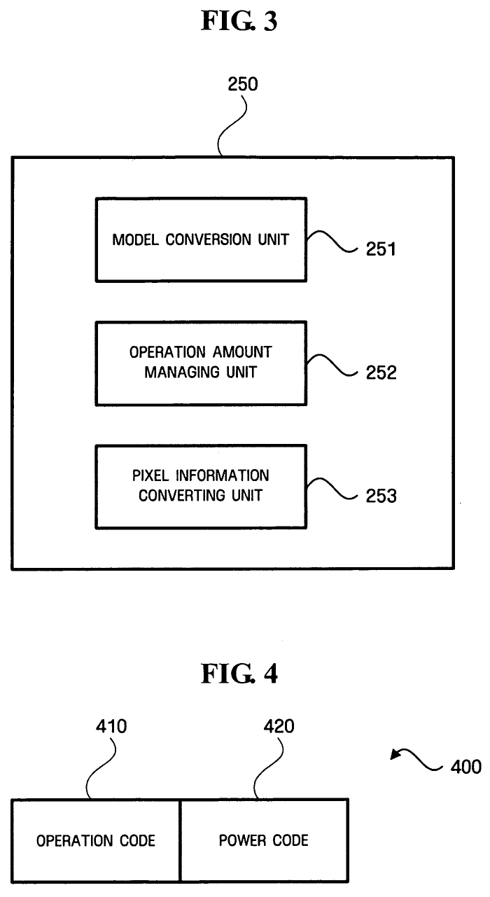

The graphics management unit 250 converts properties of the graphic object, referring to the remaining power. Here, the properties of the graphic object include at least one of a polygon model, an operation amount, and pixel information. The graphics management unit 250 can convert the properties of the graphic object, referring to the pixel information map stored in the storage unit 240. A detailed description of the graphics management unit 250 will be made below with reference to FIG. 3.

The light source management unit 260 adjusts the intensity of light emitted the light source, referring to the remaining power. Here, it is assumed that the display unit 300 is a liquid crystal display. That is, the light source management unit 260 adjusts the intensity of light emitted from a backlight of the liquid crystal display. When the supplied power is low, the light source management unit 260 lowers the intensity of light emitted from the backlight and adjusts the arrangement of liquid crystal which is included in the display unit 300, thereby increasing light transmittance.

The model optimizing unit 270 creates an optimized polygon model with respect to an input three-dimensional polygon model. That is, in order to express the three-dimensional polygon model as a polygon mesh of triangles, the model optimizing unit 270 determines the positions of the vertexes corresponding to viewpoints, colors, surface materials, and normal direction vectors. Here, the model optimizing unit 270 may create a simplified polygon model in which the number of vertices or the number of edges is decreased so as to express a complex three-dimensional polygon model.

The graphic operation unit 280 calculates coordinates and colors of triangle vertices according to the polygon model created by the model optimizing unit 270. That is, the graphic operation unit 280 calculates the coordinates and colors of triangle vertices that are displayed through the display unit 300. The graphic operation unit 280 deletes invisible surfaces or vertices and reconstructs triangles that are lost by screen edges. In addition, when the light source is used for the graphic object, the graphic operation unit 28 calculates colors of the vertices by calculating the effect of the light source with respect to the surface normal direction vectors.

The graphics processing unit 290 generates information on pixels inside the triangle for the coordinates and the colors of the triangle vertices. That is, the graphics processing unit 290 calculates colors of screen pixels corresponding to an actual image, by using the colors of the triangle vertices and the coordinates thereof on the screen, and the graphics processing unit 290 stores the calculated colors in a pixel buffer. The graphics processing unit 290 performs calculation at least once on all of the pixels that are outputted to the screen. Here, when the graphic object covers the entire screen and there is no surface at the back of the graphic object, time necessary to calculate the entire screen is time obtained by multiplying time spent calculating one pixel by the entire screen size.

The display unit 300 displays the graphic object whose properties are converted by the graphics management unit 250, with the intensity of light from the light source that is adjusted by the light source management unit 260. As described above, it is assumed that the display unit 300, which is the liquid crystal display, displays the graphic object. In this case, when the intensity of light from the backlight is reduced by the light source management unit 260, the liquid crystal molecules are rearranged so as to increase light transmittance.

FIG. 3 is a block diagram showing a graphics management unit according to an exemplary embodiment of the present invention. The graphics management unit 250 includes a model conversion unit 251, an operation amount managing unit 252, and a pixel information converting unit 253.

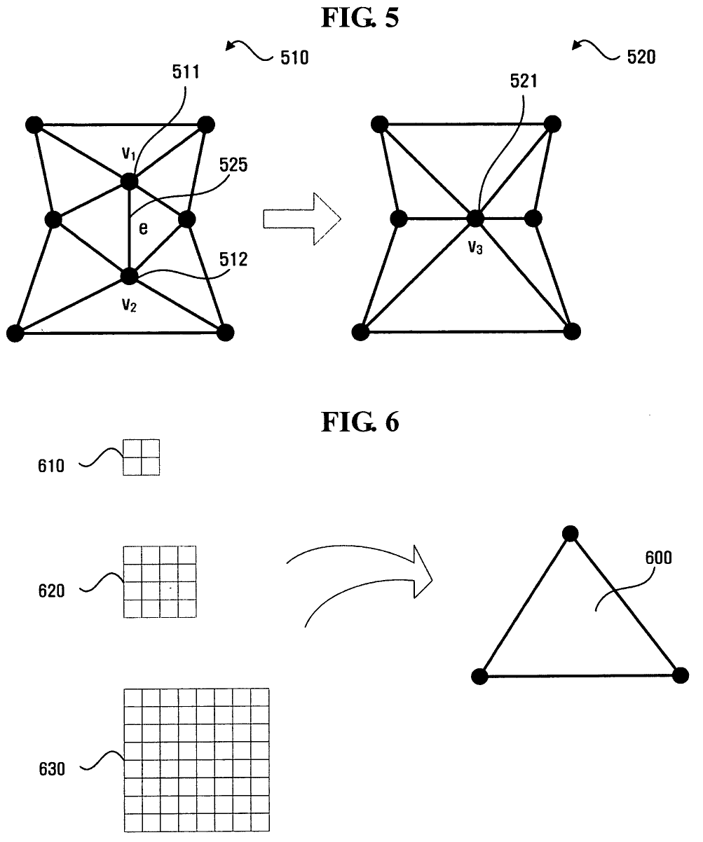

The model conversion unit 251 converts a polygon model of a graphic object. That is, the model conversion unit 251 adjusts the number of polygons that are displayed in response to viewpoints. Therefore, vertex positions, colors, surface materials, normal direction vectors, and the like may be adjusted. The model conversion unit 251 converts the polygon model, referring to the remaining power. The lower the remaining power is, the more number of polygons the model conversion unit 251 deletes. When the remaining power is sufficient, the model conversion unit 251 may not delete polygons. The deletion of the polygons may be made by applying edge collapse. A detailed description of the edge collapse will be made below with reference to FIG. 5.

The model optimizing unit 270 creates a polygon model corresponding to the polygon model converted by the model conversion unit 251.

The operation amount managing unit 252 adjusts an operation amount on the coordinates and the colors of the vertices of the polygon model. To do so, the operation amount managing unit 252 may adjust a voltage and a frequency that are supplied to the graphic operation unit 280. That is, to cause the graphic operation unit 280 to perform a large amount of operation, the operation amount managing unit 252 may supply a high voltage and a high frequency to the graphic operation unit 280. On the other hand, to cause the graphic operation unit 280 to perform a small amount of operation, the operation amount managing unit 252 may supply a low voltage and a low frequency to the graphic operation unit 280.

The operation amount managing unit 252 also operates according to the remaining power. When the remaining power is insufficient, the operation amount managing unit 252 supplies a low voltage and a low frequency to the graphic operation unit 280. On the other hand, when the remaining power is sufficient, the operation amount managing unit 252 supplies a high voltage and a high frequency to the graphic operation unit 280.

The pixel information converting unit 253 converts pixel information that is applied to a predetermined area of the graphic object determined according to the coordinates and the colors of the vertices. That is, the pixel information converting unit 253 converts the resolution of the pixel information that is applied to the predetermined area of the graphic object. The pixel information converting unit 253 can convert the pixel information, referring to the previously created pixel information map.

The pixel information map includes pixel information on a specific material according to resolution. When the remaining power is insufficient, pixel information of low resolution is extracted, and when the remaining power is sufficient, pixel information of high resolution is extracted. The extracted pixel information of low or high resolution is applied to the area of the graphic object by the graphics processing unit 290.

FIG. 4 is a diagram showing a control code according to an exemplary embodiment of the present invention. A control code 400 includes an operation code 410 and a power code 420.

The operation code 410 indicates a corresponding operation. The corresponding operation includes model conversion, operation amount adjustment, pixel information conversion, and light source control. Flags of 1, 2, 3, and 4 may correspond to codes for the operations.

In addition, the power code 420 is a code that is given by the control unit 230 with reference to the remaining power. Flags of 1 to 10 may correspond to the power code 420. That is, a flag 0 is inserted when the remaining power is sufficient, and a flag 10 is inserted when the remaining power is insufficient. As a result, it is possible for the control unit 230 to control power that is consumed by the graphics management unit 250 and the light source management unit 260.

For example, when the control code 400 having the flag 1 inserted into the operation code 410 and the flag 5 inserted into the power code 420 is transmitted to the graphics management unit 250, the graphics management unit 250 converts a polygon model such that power is consumed to an intermediate degree. In addition, when the control code 400 having the flag 4 inserted into the operation code 410 and the flag 10 inserted into the power code 420 is transmitted to the light source management unit 260, the light source management unit 260 controls the light source such that the minimum power is consumed.

FIG. 5 is a diagram illustrating edge collapse according to an exemplary embodiment of the present invention. As described above, the model conversion unit 251 may perform edge collapse to reduce the number of polygons. Here, preferably, but not necessarily, an edge to be collapsed is an edge that is positioned upward.

In FIG. 5, reference numeral 510 illustrates a graphic object composed of a plurality of triangles, and a character. “e” (525) between v₁ (511) and v₂ (512) indicates a top edge. Here, when the remaining power is insufficient, the model conversion unit 251 deletes “e” (525), whereby v₁ (511) and v₂ (512) are incorporated into v₃ (512), which is shown like reference numeral 520.

The edge collapse is performed according to the remaining power. When the remaining power is insufficient, a larger number of edges may be collapsed. As a result, the number of triangle meshes is reduced, resulting in a reduction in power consumption.

FIG. 6 is a diagram illustrating determination of pixel properties of a graphic object with reference to a pixel information map according to an exemplary embodiment of the present invention.

A pixel information map is stored in the storage unit 240. The pixel information map includes various types of pixel information for expressing a surface material of a graphic object. In addition, the pixel information map according to the exemplary embodiment of the present invention includes pixel information according to resolution for expressing the same kind of material. When the remaining power is sufficient, pixel information of high resolution is extracted, and when the remaining power is insufficient, pixel information of low resolution is extracted. The extracted pixel information of high or low resolution is applied to the area of the graphic object.

FIG. 6 illustrates 2×2 pixel information 610, 4×4 pixel information 620, and 8×8 pixel information 630. When the remaining power is sufficient, the 8×8 pixel information 630 is applied to an area 600 of the graphic object. When the remaining power is insufficient, the 2×2 pixel information 610 is applied to the area 600 of the graphic object.

In addition, when the remaining power is very insufficient, the pixel information may not be applied to the area 600 of the graphic object.

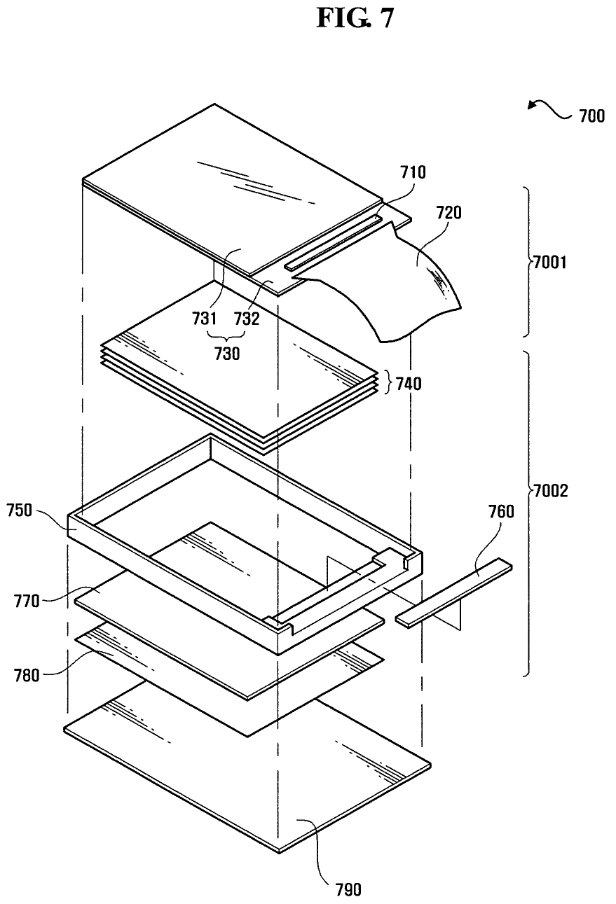

FIG. 7 is an exploded perspective view of a liquid crystal display according to an exemplary embodiment of the present invention. A liquid crystal display 700 includes a liquid crystal panel assembly 7001, a backlight unit 7002, an upper receiving container 750, and a lower receiving container 790.

The liquid crystal panel assembly 7001 includes a liquid crystal panel 730 having a thin film transistor array panel 731 and a common electrode panel 732, liquid crystal (not shown), a driving integrated circuit (IC) 710, and a flexible printed circuit board 720.

The liquid crystal panel 730 is a device that displays image information, such as text, figures, and arbitrary icons, by adjusting transmittance of light passing through a liquid crystal layer (not shown) according to the level of a voltage applied. The liquid crystal panel 730 includes the thin film transistor array panel 731 having thin film transistors formed thereon, the common electrode panel 732 having colors filters formed thereon, and the liquid crystal layer (not shown) interposed between the thin film transistor array panel 731 and the common electrode panel 732.

The thin film transistor array panel 731 includes a plurality of gate lines, a plurality of data lines, and pixel electrodes. The gate lines extend in a row direction to transmit gate signals, and the data lines extend in a column direction to transmit data signals. Pixels are connected to the gate lines and the data lines, and include switching elements and storage capacitors.

The common electrode panel 732 is positioned on the thin film transistor array panel 731, and includes red, green, and blue color filters formed in areas corresponding to the pixel electrodes so as to display colors in the pixels. Here, the color filters may be formed above or below the pixel electrodes. Further, a common electrode formed of a transparent conductive material, such as ITO (indium tin oxide) or IZO (indium zinc oxide), is formed on the color filters.

The liquid crystal layer (not shown) is interposed between the common electrode panel 732 and the thin film transistor array panel 731, and has dielectric anisotropy. The liquid crystal layer (not shown) has a thickness of about 5 μm, and is a TN (twisted nematic) liquid crystal layer. The orientation of the liquid crystal molecules in the liquid crystal layer is changed by a voltage applied from the outside, whereby the transmittance of light passing through the liquid crystal layer is adjusted.

The backlight unit 7002 includes optical sheets 740, a lamp assembly 760, an optical waveguide 770, and a reflective sheet 780. Here, the optical waveguide 770 guides light that is emitted from the lamp assembly 760. The optical waveguide 770 is a panel formed of a plastic-based transparent material such as acryl. The optical waveguide 770 guides the light emitted from the lamp assembly 760 such that the light travels toward the liquid crystal panel 730 that is placed above the optical waveguide 770. Therefore, various kinds of patterns that change the traveling direction of light incident on the inner part of the optical waveguide 770 toward the liquid crystal panel 730 may be printed on the rear surface of the optical waveguide 770.

The lamp assembly 760 is inserted into one side of the optical waveguide 770 inside the upper receiving container 750. For example, an LED (light emitted diode), a CCFL (cold cathode fluorescent lamp), or an EEFL (external electrode fluorescent lamp) may be used as the lamp used in the lamp assembly 760.

The light source management unit 260 according to the exemplary embodiment of the present invention reduces the intensity of light emitted from the lamp assembly 760 and increases the transmittance of light passing through the liquid crystal layer. As a result, the graphic object may be displayed without a decrease in brightness thereof. Meanwhile, when the remaining power is very insufficient, the light source management unit 260 may not increase the transmittance of light passing through the liquid crystal layer.

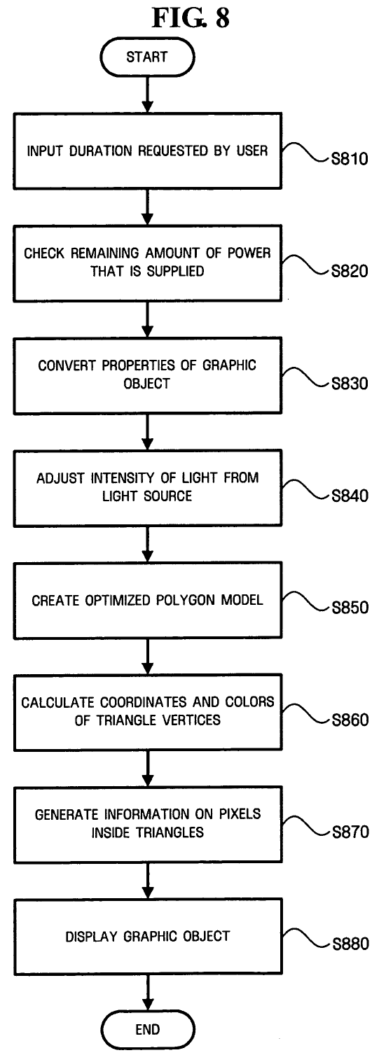

FIG. 8 is a diagram showing a process of displaying a graphic object with low power consumption according to one exemplary embodiment of the present invention.

In order to display a graphic object with low power consumption, first, the input unit 210 of the display apparatus 200 receives the time required for the duration of the display apparatus 200 from the user (S810). The user can input the time required for the duration in the units of hours or minutes through the input unit 210 that has buttons, wheels, a keypad, or a touch pad. When the user does not input the time required for the duration, the display apparatus 200 may stop the operation.

When the time required for the duration is input, the remaining power checking unit 220 checks the remaining amount of power that is supplied (S820). The remaining power checking unit 220 checks the remaining power using the voltage of a battery that is provided in the display apparatus 200. Therefore, when the supplied power is commercial power, the remaining power checking unit 220 may not check the remaining power.

The input time required for the duration and the checked remaining power are transmitted to the control unit 230. The control unit 230 operates at least one of the graphics management unit 250 and the light source management unit 260 such that the graphic object can be displayed for the time required for the duration by using the remaining power.

Under the control of the control unit 230, the graphics management unit 250 converts properties of the graphic object, referring to the remaining power (S830). That is, the graphics management unit 250 converts a polygon model of the graphic object, adjusts an operation amount on the coordinates and colors of vertices of the polygon model, or converts pixel information that is applied to a predetermined area of the graphic object that is determined according to the coordinates and the colors of the vertices of the polygon model.

The control unit 230 can control power consumption by transmitting the above-described control code 400 to the graphics management unit 250 and the light source management unit 260. The graphics management unit 250 having received the control code 400 converts the properties of the graphic object, referring to the remaining power. That is, the control unit 230 performs at least any one of the conversion of the polygon model, the adjustment of the operation amount, and the conversion of the pixel information, referring to the operation code 410 and the power code 420 that are included in the control code 400. When the pixel information is converted, the graphics management unit 250 can refer to the pixel information map that is stored in the storage unit 240.

In addition, the graphics management unit 250 having received the control code 400 adjusts the intensity of light from the light source by referring to the remaining power (S840).

The model optimizing unit 270 creates an optimized polygon model with respect to a three-dimensional polygon model according to the properties converted by the graphics management unit 250 (S850). The created polygon model is transmitted to the graphic operation unit 280, and the graphic operation unit 280 calculates the coordinates and colors of triangle vertices according to the transmitted polygon model (S860). At this time, since the graphic operation unit 280 performs the operation on the basis of a voltage and a frequency that are controlled by the graphics management unit 250, it is possible to control the operation amount of the graphic operation unit 280.

Further, the graphics processing unit 290 generates information on pixels inside the triangles for the coordinates and the colors of the triangle vertices (S870). The information may be pixel information that is converted by the graphics management unit 250, and at this time, the pixel information map stored in the storage unit 240 may be referenced.

The created graphic object is transmitted to the display unit 300, and the display unit 300 displays the graphic object having converted properties, with the intensity of light from the light source that is adjusted by the light source management unit 260 (S880).

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

According to the apparatus and method for displaying a graphic object with low power consumption, the following effects can be obtained.

First, it is possible to reduce power consumption by adjusting complexity and surface properties of a graphic object that is displayed and increasing the transmittance of light emitted from a light source of a liquid crystal display.

Second, it is possible to maintain the operation of the apparatus as long as the user desires because the graphic object is displayed with consideration of the remaining power of a power supply unit.

What is claimed is:

1. An apparatus for displaying a graphic object with low power consumption, the apparatus comprising:
a remaining power checking unit which checks a remaining amount of power that is supplied;
a graphics management unit which converts properties of the graphic object on the basis of the remaining power;
a light source management unit which adjusts intensity of light emitted from a light source on the basis of the remaining power; and
a display unit which displays the graphic object having converted properties, with the adjusted intensity of the light emitted from the light source.

2. The apparatus of claim 1, wherein the graphics management unit comprises:
a model conversion unit which converts a polygon model of the graphic object;
an operation amount managing unit which adjusts an operation amount on coordinates of vertices of the polygon model and colors of vertices of the polygon model; and
a pixel information converting unit which converts pixel information that is applied to a predetermined area of the graphic object that is determined according to the coordinates and the colors of the vertices of the polygon model.

3. The apparatus of claim 2, further comprising:
a model optimizing unit which generates an optimized polygon model with respect to a three-dimensional polygon model according to the converted polygon model;
a graphic operation unit which performs an operation on the coordinates and the colors of the vertices of the polygon model according to the adjusted operation amount; and
a graphics processing unit which applies the converted pixel information to the predetermined area.

4. The apparatus of claim 2, wherein the pixel information converting unit converts the pixel information by referring to a previously created pixel information map.

5. The apparatus of claim 4 further comprising a storage unit storing the pixel information map.

6. The apparatus of claim 1, wherein the light source comprises a backlight of a liquid crystal display.

7. The apparatus of claim 1, further comprising a control unit operating at least one of the graphics management unit and the light source management unit such that the graphic object is displayed during a duration requested by a user by using the remaining power.

8. A method of displaying a graphic object with low power consumption, the method comprising:
checking remaining amount of power that is supplied;
converting properties of the graphic object on the basis of the remaining power;
adjusting intensity of light emitted from a light source on the basis of the remaining power; and
displaying the graphic object having the converted properties, with the adjusted intensity of the light emitted from the light source.

9. The method of claim 8, wherein the converting the properties of the graphic object on the basis of the remaining power comprises:
converting a polygon model of the graphic object;
adjusting an operation amount on coordinates of vertices of the polygon model and colors of vertices of the polygon model; and
converting pixel information that is applied to a predetermined area of the graphic object that is determined according to the coordinates and the colors of the vertices of the polygon model.

10. The method of claim 9, further comprising:
generating an optimized polygon model with respect to a three-dimensional polygon model according to the converted polygon model;
performing an operation on the coordinates and the colors of the vertices of the polygon model according to the adjusted operation amount; and
applying the converted pixel information to the area.

11. The method of claim 9, wherein the converting the pixel information comprises converting the pixel information with reference to a previously created pixel information map.

12. The method of claim 11, further comprising storing the pixel information map.

13. The method of claim 8, wherein the light source comprises a backlight of a liquid crystal display.

14. The method of claim 8, further comprising performing at least one of the converting the properties of the graphic object and the adjusting the intensity of the light emitted from the light source such that the graphic object is displayed during a duration requested by a user by using the remaining power.
